(19) United States
(12) Patent Application Publication
(10) Pub. No.: US 2026/0252237 A1
(43) Pub. Date: Aug. 27, 2026

(54) APPARATUS AND OPERATION METHOD FOR PERFORMING A READ OPERATION IN A MEMORY DEVICE

(71) Applicant: SK hynix Inc., Gyeonggi-do (KR)

(72) Inventor: Gun Ryoung HAN, Gyeonggi-do (KR)

(21) Appl. No.: 19/258,920

(22) Filed: Jul. 3, 2025

(30) Foreign Application Priority Data
Feb. 25, 2025 (KR) 10-2025-0024090

(51) Int. Cl. G06F 3/06

(52) U.S. Cl. CPC G06F 3/0611; G06F 3/0634; G06F 3/0656; G06F 3/0679

(57) ABSTRACT

A memory system includes a memory device and a controller. The memory device is configured to store data corresponding to a data input/output command. The controller is configured to receive, from an external device, the data input/output command and a notification of Slack Space Recycling (SSR) corresponding to the data input/output command, and control, based on the notification, a buffer for processing data and metadata corresponding to the data input/output command.

### CROSS-REFERENCE TO RELATED APPLICATIONS

This patent application claims the benefit of Korean Patent Application No. 10-2025-0024090, filed on Feb. 25, 2025, the entire disclosure of which is incorporated herein by reference.

### TECHNICAL FIELD

Embodiments of the present disclosure described herein relate to a data storage device or a memory system, and more particularly, to an apparatus and an operating method for controlling a buffer in a memory system.

### BACKGROUND

A data processing system including a memory system or a data storage device has been developed to store more data in the data storage device, store data in the data storage device more quickly, and output data stored in the data storage device more quickly. The data storage device may include non-volatile memory cells and/or volatile memory cells for storing data. Additionally, the memory cells may store multi-bit data. In the memory system, a controller may control a buffer capable of storing input/output data and metadata to improve data input/output performance.

### BRIEF DESCRIPTION OF THE DRAWINGS

The description herein makes reference to the accompanying drawings wherein like reference numerals refer to like parts throughout the figures.

FIG. 1 illustrates data communication between a host and a memory system according to an embodiment of the present disclosure.

FIG. 2 illustrates a configuration of a host and a memory system according to an embodiment of the present disclosure.

FIG. 3 illustrates a configuration of a memory system according to an embodiment of the present disclosure.

FIG. 4 illustrates a host file system and a memory system according to an embodiment of the present disclosure.

FIG. 5 illustrates an embodiment of log-structured file system cleaning (LFS cleaning).

FIG. 6 illustrates an embodiment of hole-plugging.

FIG. 7 illustrates an embodiment of slack space recycling (SSR).

FIG. 8 illustrates buffer control of a memory system according to an embodiment of the present disclosure.

FIG. 9 illustrates a configuration of a memory system according to an embodiment of the present disclosure.

### DETAILED DESCRIPTION

Various embodiments of the present disclosure are described below with reference to the accompanying drawings. Elements and features of this disclosure may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. Furthermore, the terms in a claim do not foreclose the apparatus from including additional components, e.g., an interface unit, circuitry, etc.

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational, e.g., is not turned on nor activated. The block/unit/circuit/component used with the “configured to” language includes hardware, for example, circuits, memory storing program instructions executable to implement the operation, etc. Additionally, “configured to” can include a generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

As used in this disclosure, the term ‘circuitry’ or ‘logic’ refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘circuitry’ or ‘logic’ applies to all uses of this term in this application, including in any claims. As a further example, as used in this application, the term “circuitry” or “logic” also covers an implementation of merely a processor (or multiple processors) or a portion of a processor and its (or their) accompanying software and/or firmware. The term “circuitry” or “logic” also covers, for example, and if applicable to a particular claim element, an integrated circuit for a storage device.

As used herein, the terms “first,” “second,” “third,” and so on are used as labels for nouns that they precede, and do not imply any type of ordering (e.g., spatial, temporal, logical, etc.). The terms “first” and “second” do not necessarily imply that the first value must be written before the second value. Further, although the terms may be used herein to identify various elements, these elements are not limited by these terms. These terms are used to distinguish one element from another element that otherwise has the same or similar names. For example, a first circuitry may be distinguished from a second circuitry.

Further, the term “based on” is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

Herein, a data entry, an entry of data, an item of data, or a data item may be a sequence of bits. For example, the data entry may include the contents of a file, a portion of the file, a page in memory, an object in an object-oriented program, a digital message, a digital scanned image, a part of a video or audio signal, metadata or any other entity which can be represented by a sequence of bits. According to an embodiment, the data entry may include a discrete object. According to another embodiment, the data entry may include an information unit processed or handled for a data input/output operation. According to another embodiment, the data entry may include an information unit within a transmission packet between two different components.

Embodiments of the present disclosure can provide a memory device, a memory system including the memory device, a controller included in the memory system, or a data processing device including the memory system.

Embodiments of the present disclosure can provide a memory system, a data processing system, and an operation process or a method, which may quickly and reliably process data into a memory device by reducing operational complexity and performance degradation of the memory system, thereby enhancing usage efficiency of the memory device.

An embodiment of the present disclosure can provide an apparatus and a method for improving data input/output performance of the memory system by controlling the usage of a buffer established for processing data and metadata corresponding to a data input/output command when a host transmits a notification for slack space recycling (SSR) to the memory system.

An embodiment of the present disclosure can provide an apparatus and method for adaptively changing a size of the buffer established for processing data and metadata associated with the data when data input along with a data input/output command transmitted by a host is generated through operations such as log file system cleaning (LFS cleaning), hole-plugging, and slack space recycling.

In an embodiment, a memory system can include a memory device configured to store data corresponding to a data input/output command; and a controller configured to receive, from an external device, the data input/output command and a notification of Slack Space Recycling (SSR) corresponding to the data input/output command, and control, based on the notification, a buffer for processing data and metadata corresponding to the data input/output command.

The notification can be transmitted from the external device based on log-structured file system cleaning (LFS cleaning) and hole-plugging performed within the external device.

The notification, the data, and the metadata can be generated from a log-structured file system (LFS) within the external device.

The buffer can include a first buffer established for processing the data and a second buffer established for processing the metadata. The controller can be configured to reduce a size of the first buffer and increase a size of the second buffer based on the notification.

The data can include read data or write data corresponding to the data input/output command. The first buffer can include a read buffer for storing the read data and a write buffer for storing the write data.

The metadata can include map data corresponding to the data.

The controller can be configured to adjust usage of the buffer based on a termination notification of the Slack Space Recycling (SSR), which is transmitted from the external device.

The buffer can include a first buffer established for processing the data and a second buffer established for processing the metadata. The controller can be configured to increase a size of the first buffer and reduce a size of the second buffer, based on the termination notification.

The buffer can be established in a volatile memory included in, or linked to, the controller.

The volatile memory can be a Static Random Access Memory (SRAM) included in the controller.

In an embodiment, a data processing system can include at least one host configured to generate a data input/output command or a notification of Slack Space Recycling (SSR); and at least one memory system configured to control, based on the notification transmitted from the host, a buffer established for processing the data input/output command.

The at least one host can be configured to generate the notification after performing log file system (LFS) cleaning and hole-plugging.

The at least one host can be configured to generate the notification, the data, and the metadata through a log-structured file system (LFS) within the at least one host.

The log-structured file system (LFS) can include a Flash-Friendly File System (F2FS).

The buffer can include a first buffer established for processing the data and a second buffer established for processing the metadata. The at least one memory system can be configured to reduce a size of the first buffer and increase a size of the second buffer based on the notification.

The data can include read data or write data corresponding to the data input/output command. The first buffer can include a read buffer established for storing the read data and a write buffer established for storing the write data.

The at least one memory system can be configured to adjust usage of the buffer based on a termination notification of the Slack Space Recycling (SSR), which is transmitted from the at least one host.

The buffer can include a first buffer established for processing the data and a second buffer established for processing the metadata. The at least one memory system can be configured to increase a size of the first buffer and reduce a size of the second buffer, based on the termination notification.

In another embodiment, a method for operating a memory system can include receiving, from a host, a notification of Slack Space Recycling (SSR); and adjusting, based on the notification, usage of buffers established for processing data and metadata corresponding to a data input/output command which is transmitted from the host.

The adjusting the usage of the buffers can include reducing, based on the notification, a size of a first buffer established for processing data corresponding to the data input/output command; and increasing, based on the notification, a size of a second buffer established for processing metadata corresponding to the data input/output command.

The method can further include receiving, from the host, a termination notification of the Slack Space Recycling (SSR), increasing, based on the termination notification, a size of a first buffer established for processing data corresponding to the data input/output command; and reducing, based on the termination notification, a size of a second buffer established for processing metadata corresponding to the data input/output command.

An embodiment described herein can provide an apparatus and a method for improving a data input/output operation of a memory system or a data processing system. Embodiments will now be described with reference to the accompanying drawings, wherein like numbers reference like elements.

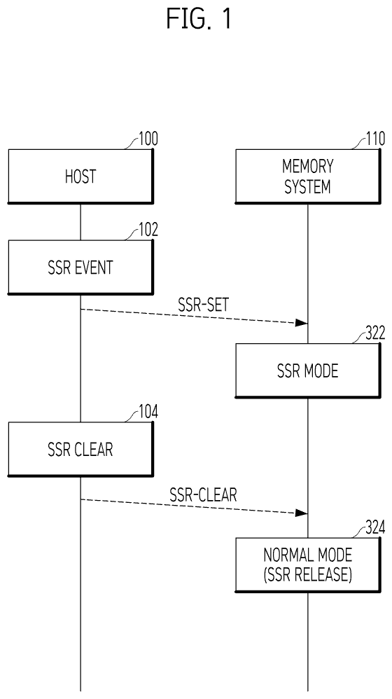

FIG. 1 illustrates data communication between a host and a memory system according to an embodiment of the present disclosure.

Referring to FIG. 1, a host 100 can perform data communication with a memory system 110. The host 100 can generate a request or a command to store data or read stored data in response to a user's request. The memory system 110 can store data or transmit stored data based on the request or the command of the host 100.

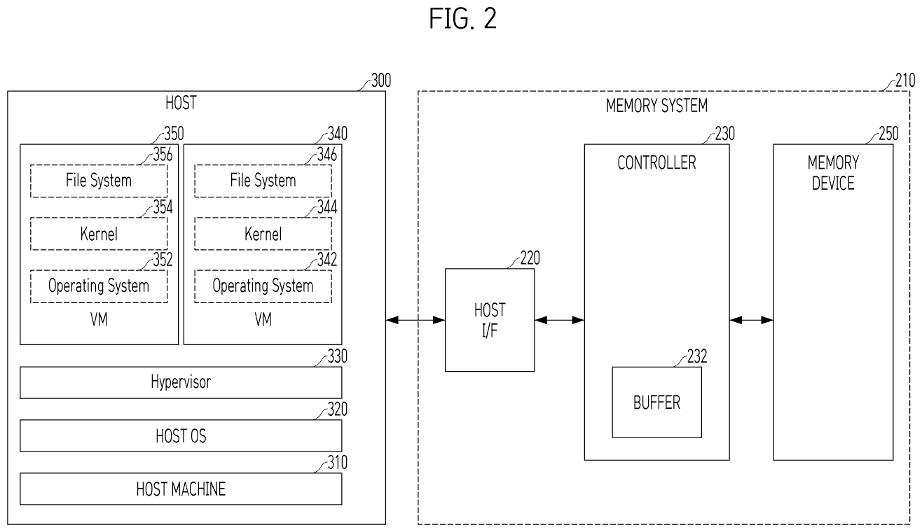

The host 100 can include a file system including software that defines a method for storing and managing data. The file system used in the host 100 can be diverse, and each file system can have different characteristics and purposes. Internal components of the host 100 including the file system will be described later with reference to FIG. 2.

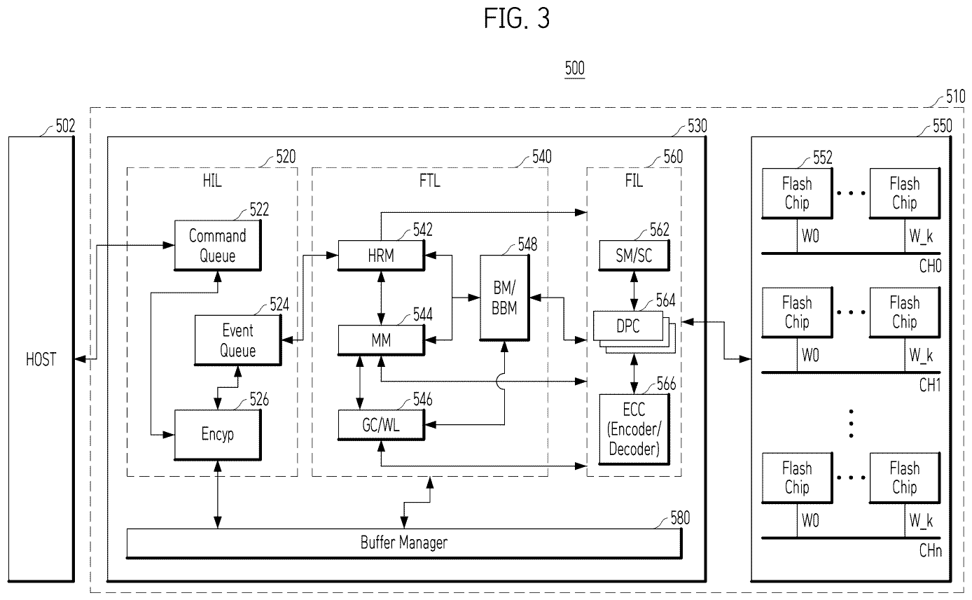

The host 100 can transmit a data input/output command (e.g., a read command, a write command, etc.) to the memory system 110. The memory system 110 can store data or output stored data based on a data input/output command input by the host 100. Internal components included in the host 100 and the memory system 110 will be described later with reference to FIGS. 2 and 3.

The host 100 can use slack space recycling (SSR) to configure write data to be transmitted to the memory system 110 before providing the write data to the memory system 110 (operation 102). The host 100 can transmit a notification (SSR-SET) for the slack space recycling (SSR) to the memory system 110, rather than a data input/output command. The memory system 110 can operate in a slack space recycling (SSR) mode based on the notification (SSR-SET) input by the host 100 (operation 322). In addition, the host 100 does not use the slack space recycling (SSR) when it is determined that the SSR might not be necessary (operation 104). According to an embodiment, the host 100 can transmit a clear notification (SSR-CLEAR) for the slack space recycling (SSR) to the memory system 110. The memory system 110 can operate in the normal mode from the slack space recycling (SSR) mode based on the clear notification (SSR-CLEAR) transmitted by the host 100 (operation 324). Here, the normal mode can refer to an operating state in which the memory system 110 performs a data input/output operation when the host 100 does not want to store or read data generated through the slack space recycling (SSR) operation.

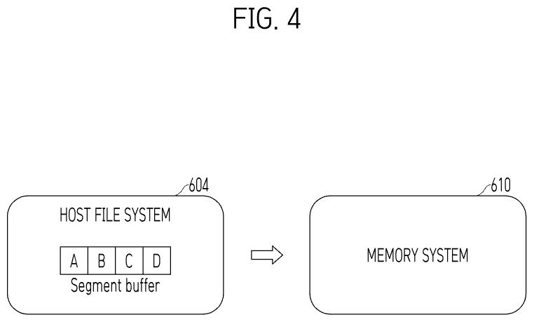

In a first case in which the file system within the host 100 performs an operation for the slack space recycling (SSR) to store data in the memory system 110 and in a second case in which the data is stored in the memory system 110 without performing the operation for the slack space recycling (SSR), a format (e.g., packet configuration) of data transmitted by the host 100 to the memory system 110 can be different. For example, a first data segment generated by the file system in the host 100 performing the operation of the slack space recycling (SSR) can include metadata including more logical addresses (e.g., logical block addresses) than a second data segment generated without performing the operation for the slack space recycling (SSR). The second data segment can include data corresponding to consecutive logical block addresses, while the first data segment can include data corresponding to random logical block addresses. The difference between the first and second data segments generated by the host 100 will be described later with reference to FIGS. 4 to 7.

Due to the above-described difference, the memory system 110 can generate, control, or manage more map data for the first data segment than for the second data segment. For example, when the second data segment including data corresponding to consecutive logical block addresses is stored in the memory system 110, it might be easy for the memory system 110 to link (e.g., map) logical block addresses of the second data segment with physical addresses used by the memory system 110. However, when storing the first data segment including pieces of data corresponding to random logical block addresses in the memory system 110, the memory system 110 should individually connect (map) the random logical block addresses to physical addresses, which can increase operational complexity thereof.

In addition, when the logical address corresponding to the read command is random when the host 100 reads data stored in the memory system 110, the range of addresses that the memory system 110 should convert can increase. When the range of addresses that the memory system 110 should convert increases, a size of map data that the memory system 110 loads for address conversion could need to increase. When the memory system 110 does not secure a sufficient size of a buffer or a cache memory for loading the map data, the memory system 110 could repeatedly load and evict some of the map data while performing the address conversion. In this case, the data input/output performance of the memory system 110 can deteriorate.

The memory system 110 according to an embodiment of the present disclosure can operate in a slack space recycling (SSR) mode in response to the notification (SSR-SET) for the slack space recycling (SSR) (operation 322). That is, the memory system 110 can control the use of a buffer for processing data and metadata corresponding to the data input/output command transmitted from the host 100 in response to receiving the notification (SSR-SET) for the slack space recycling (SSR) corresponding to a data input/output command. For example, in the slack space recycling (SSR) mode, the memory system 110 can increase a space or an area for loading map data. When the space for loading map data is increased, the memory system 110 could reduce the number of loading and eviction operations of the map data. The memory system 110 could reduce a size of a first buffer established (or set) for processing data and increase a size of a second buffer established for processing metadata, based on the notification (SSR-SET). When increasing the size of the second buffer that processes metadata, the memory system 110 can secure the space or the area capable of loading map data of sufficient size.

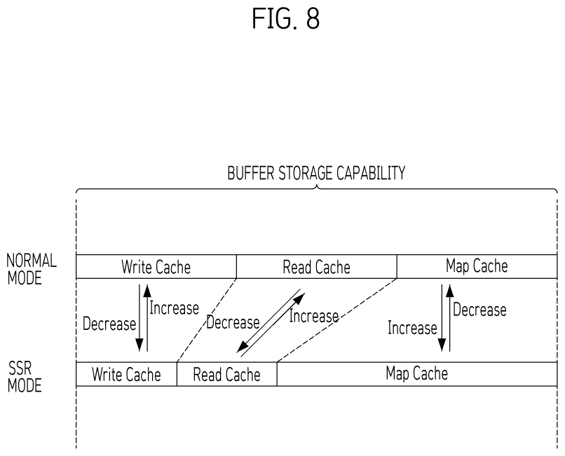

In addition, in response to receiving the clear notification (SSR-CLEAR) of the slack space recycling (SSR) transmitted from the host 100, the memory system 110 can control the usage of buffers established for processing data and metadata. For example, the memory system 110 can increase the size of the first buffer that stores data and reduce the size of the second buffer that stores metadata, based on the clear notification (SSR-CLEAR). Based on the clear notification (SSR-CLEAR) of the slack space recycling (SSR), the memory system 110 could improve data input/output performance by increasing a space or an area capable of storing read data or write data corresponding to data input/output commands rather than securing the space or the area for loading map data. A method for controlling the usage of buffers established for processing data and metadata in the memory system 110, based on the notification (SSR-SET) and the clear notification (SSR-CLEAR) for the slack space recycling (SSR), is described below with reference to FIG. 8.

FIG. 2 illustrates a configuration of a host and a memory system according to an embodiment of the present disclosure.

Referring to FIG. 2, a host 300 can perform data communication with a memory system 210. A plurality of virtual machines (VMs) 340, 350 can be operated on or within the host 300.

The host 300 can include a host machine 310 and a host operating system 320 on or within which the plurality of virtual machines (VMs) 340, 350 can be operated. The host machine 310 can include a physical computing device on which a virtual machine is executed. For example, a host machine 310 can include plural hardware-related components (e.g., processor, memory, storage device, etc.). The host machine 310 can have the ability to run the plurality of virtual machines 340, 350 simultaneously, and can allocate resources to the plurality of virtual machines 340, 350 through virtualization software (e.g., a hypervisor 330).

A host operating system 320 can include an operating system running on the host machine 310. The host operating system 320 can directly interact with the host machine 310, which is physical hardware, and can provide an environment in which the hypervisor 330 could be installed. The host operating system 320 can manage the plurality of virtual machines 340, 350 and allocate resources required by the plurality of virtual machines 340, 350.

The hypervisor 330 can act as an interface between the host machine 310, which is physical hardware, and the plurality of virtual machines 340, 350. There are two types of hypervisors 330. A type 1 hypervisor (e.g., VMware ESXi, Microsoft Hyper-V) can run directly on the host machine 310, which is a physical hardware, and can manage the plurality of virtual machines 340, 350. On the other hand, a type 2 hypervisor (e.g., VMware Workstation, Oracle VirtualBox) can run on the host operating system 320 and can support the plurality of virtual machines 340, 350 on the host operating system 320.

The plurality of virtual machines 340, 350 can be associated with an independent computer environment provided through virtualizing the hardware of the host machine 310. Each of the plurality of virtual machines 340, 350 can run its own operating system 342, 352 and run applications on its own operating system 342, 352. The plurality of virtual machines 340, 350 can share resources of the host machine 310, but operate independently of each other. Therefore, an issue or a problem occurring in the first virtual machine 340 might not affect the second virtual machine 350.

Each of the plurality of virtual machines 340, 350 can include an operating system 342, 352, a kernel 344, 354, and a file system 346, 356. The operating system 342, 352 within the plurality of virtual machine 340, 350 can include software that enables the virtual machine (340, 350) to operate independently. The operating system 342, 352 can play a role in allowing a user to execute an application, managing hardware resources, and handling interactions between a user and the host system 300. The operating system 342, 352 within the plurality of virtual machines 340, 350 does not directly use the hardware of the host machine 310, but uses virtualized resources through the hypervisor 330. Therefore, the operating system 342, 352 within the plurality of virtual machines 340, 350 can operate independently from the host operating system 320.

The kernel 344, 354 can manage or control the interaction between hardware and software. The kernel 344, 354 can perform a basic system function such as memory management, process management, and device management. According to an embodiment, the kernel 344, 354 can be viewed as a component of the operating system 342, 352. The kernel 344, 354 within the plurality of virtual machines 340, 350 can manage virtualized hardware resources and can allocate resources requested by the plurality of virtual machines 340, 350. The kernel 344, 354 can have a significant impact on the performance and stability of the plurality of virtual machines 340, 350.

The file system 346, 356 can include software that defines how to store and manage data. The file system 346, 356 can enable operations such as creating, deleting, reading, and writing files and directories. The file system 346, 356 in the plurality of virtual machines 340, 350 can be stored in a virtual disk image file, which can be located in a physical storage device (e.g., host memory) through the host machine 310. The plurality of virtual machines 340, 350 can manage data and enable applications to access necessary files, through the file system 346, 356.

According to an embodiment, the plurality of virtual machines 340, 350 can be configured as a container. The container can perform functions that the plurality of virtual machines 340, 350 can perform, but have a structural difference from the plurality of virtual machines 340, 350. The biggest difference between the plurality of virtual machines 340, 350 and the container can be the presence or absence of a kernel. The plurality of virtual machines 340, 350 can include a separate kernel 344, 354 distinct from the host machine 310 and the host operating system 320, while the container uses a kernel included in the host operating system 320.

The kernel 344, 354 can include the lowest level operating system software that interfaces with the computing device. The kernel 344, 354 can act as an intermediary between application executables running on the host 300, such as the computing device, and the operating system 342, 352 and the host machine 310. The machine can be interacted with so that processes, called services and servers, can obtain information from each other using inter-process communication (IPC). The kernel 344, 354 can handle disk I/O operations, network traffic, and storage. Because the plurality of virtual machines 340, 350 can include a separate kernel 344, 354 rather than using the kernel of the host operating system 320, the plurality of virtual machines 340, 350 can run an operating system 342, 353 different from the host operating system 320. Additionally, the plurality of virtual machines 340, 350 can include their own virtual file systems 346, 356 which are separate from the host machine 310 and the host operating system 320, whereas a container can use a file system that interfaces with the host machine 310 and the host operating system 320.

Referring to FIG. 2, the memory system 210 can include a memory device 250 including non-volatile memory cells, and the host 300 can include a file system for storing and managing data in the non-volatile memory device. For example, the host 300 can include a Flash-Friendly File System (F2FS), which is a file system designed for a flash memory-based storage device. The F2FS can be designed considering the characteristics of the flash memory. Unlike volatile memories such as DRAM and SRAM, a flash memory can have limited write and delete operations. The F2FS can efficiently manage program and erasure of data by reflecting the characteristics of the flash memory.

The F2FS is a log-structured file system (LFS) that can improve the writing performance by continuously recording data and metadata. In particular, the F2FS can maximize the performance by utilizing the page-based writing method of the flash memory. The log-structured file system (LFS) is designed to record data in the form of a log, so that changes to all files can be sequentially recorded in the log. This method could minimize random access of the memory system 210 and improve performance through continuous writing. Unlike other file systems, the log-structured file system (LFS) can operate by adding data to a new location when storing data in the memory system 110, so that it could support the memory system 110 to perform a write operation quickly when considering the characteristics of the flash memory that has a limitation in overwriting.

The F2FS can help extend a life of the flash memory included in the memory system 110 by periodically organizing unused blocks through garbage collection and efficiently managing storage space through this operation. When unused blocks occur as data recorded in the log accumulates, the log-structured file system (LFS) can organize the unused blocks through the garbage collection and secure a space or an area for writing new data or other data. For example, the F2FS can support operations such as the slack space recycling for the garbage collection or partial garbage collection.

The F2FS is a log-structured file system (LFS), which has a log structure. Even if the memory system 110 is suddenly stopped, it could easily recover to the last recorded status through the stored log. Therefore, the log-structured file system (LFS) could improve data integrity. According to an embodiment, the log-structured file system (LFS) such as F2FS can be integrated into a Linux kernel and used on a mobile platform such as an android operating system.

The log-structured file system (LFS) can have many advantages over other file systems, mainly in an operating environment where write operations are frequently performed, and can be used in a database system or a high-performance server. Because the log-structured file system (LFS) records the data of the file system in a form of the log, it could perform operations to improve write performance and reduce disk fragmentation. For example, the log-structured file system (LFS) can perform operations such as LFS cleaning, hole-plugging, and slack space recycling to increase efficiency and optimize a storage space. The LFS cleaning, hole-plugging, and slack space recycling are described below with reference to FIGS. 4 to 7.

Referring to FIG. 2, the memory system 210 can include a memory device 250. The host 300 can utilize the memory device 250, including non-volatile memory cells, included in the memory system 210 to store data and retrieve stored data. For example, the memory device 250 can include at least one of all types of non-volatile memory such as MRAM, NAND, NOR, and HDD. In the following description, the memory device 250 is described as a non-volatile memory (NVM) for simplification and illustration purposes.

The host 300 can include a host memory (e.g., DRAM). According to an embodiment, the data processing device 100 can include a plurality of storage devices, such as the memory system 210. For example, the data processing device 100 can include a plurality of memory systems 210 configured as a redundant array of independent disks (RAID) that function together as mass storage devices for the host 300. Also, according to an embodiment, the data processing device 100 can include a plurality of computing devices, such as the host 300. For example, the data processing device 100 can include the memory system 210 configured as a shared memory device so that the plurality of computing devices, such as the host 300, can use the memory system for data storage and retrieval.

The data processing device 100 can include the host 300 that is capable of storing and/or retrieving data in one or more storage devices (e.g., the memory system 210). As illustrated in FIG. 1, the host 300 can perform data communication with the memory system 210 via a host interface 220. The host 300 can include a wide range of devices, including mobility electronics such as automotive, electronic devices such as cell phones or MP3 players, computer servers, network attached storage (NAS) devices, desktop computers, notebook (i.e., laptop) computers, tablet computers, set-top boxes, telephones such as “smart” phones, “smart” pads, televisions, cameras, display devices, digital media players, video game consoles, video streaming devices, and the like.

The memory system 210 can include a controller 230, the memory device 250, and the host interface 220. The controller 230 can include a garbage collection processing unit 132 and at least one map data 134. Depending on an operating state, the map data 134 can include first map data 136 and second map data 138. The first map data 136 and the second map data 138 can be stored in at least one memory included in, engaged with, or linked to, the controller 230. For example, the at least one memory can include a static random access memory (SRAM) and a dynamic random access memory (DRAM). The controller 230 can determine an update of the map data 134 based on a data input/output operation corresponding to a data input/output command transmitted by the host 300, a result of garbage collection performed by the garbage collection processing unit 132, and the like.

According to an embodiment, the memory system 210 can include additional components not shown in FIG. 2 for clarity. For example, the memory system 210 can include a printed circuit board (PCB) including electrically conductive wiring, etc., to which components of the memory system 210 are mechanically attached and electrically interconnecting components of the memory system 210. In some examples, the physical dimensions and connector configurations of the memory system 210 can conform to one or more standard form factors. For example, standard form factors can include, but are not limited to, 2.5-inch data storage devices (e.g., HDD or SSD), 1.8-inch data storage devices, peripheral component interconnect (PCI), PCI expansion (PCI-X), and PCI Express (PCIe) (e.g., PCIe x1, x4, x8, x16, PCIe Mini Card, MiniPCI, etc.). According to an embodiment, the memory system 210 can be directly connected (e.g., directly soldered) to a motherboard of the host 300.

The host interface 220 of the memory system 210 can include one or both of a data bus for exchanging data with the host 300 and a control bus for exchanging commands with the host 300. The host interface 220 can operate according to any suitable protocol. For example, the host interface 220 can operate according to one or more of advanced technology attachment (ATA) (e.g., serial ATA (SATA) and parallel ATA (PATA)), universal serial bus (USB), multi-media card (MMC), fiber channel protocol (FCP), small computer system interface (SCSI), serial attached SCSI (SAS), serial advanced technology attachment (SATA), mobile industry processor interface (MIPI), PCI, PCIe, NVMe (non-volatile memory express), OpenCAPI, GenZ, Cache Coherent Interface Accelerator (CCIX), Compute Express Link (CXL), open channel solid state drive (Open Channel SSD, OCSSD), or similar protocols. An electrical connection (e.g., a data bus, a control bus, or both) of the host interface 220 can be electrically connected to the controller 230 to provide an electrical connection between the host 300 and the controller 230 to exchange data between the host 300 and the controller 230. According to an embodiment, the electrical connection of the host interface 220 can allow the memory system 210 to receive power from the host 300. For example, a power supply related device of the memory system 210 can receive power from the host 300 via the host interface 220.

The memory system 210 can include a memory device 250 including a plurality of data storage areas. According to an embodiment, the memory device 250 can be configured to store and/or retrieve data. For example, a memory die or memory chip included in the memory device 250 can receive data from the controller 230 and a message or a command instructing the memory device to store the data. Similarly, a memory die or memory chip included in the memory device 250 can receive a message instructing the memory device to retrieve the data from the controller 230. According to an embodiment, a memory die or memory chip included in the memory device 250 can be configured to store a relatively large amount of data (e.g., 128 MB, 256 MB, 412 MB, 1 GB, 2 GB, 3 GB, 8 GB, 16 GB, 22 GB, 54 GB, 128 GB, 256 GB, 412 GB, 1 TB, etc.).

According to an embodiment, the memory device 250 can include any type of non-volatile memory device, such as a Read Only Memory (ROM), a Mask ROM (MROM), a Programmable ROM (PROM), an Erasable ROM (EPROM), an Electrically Erasable ROM (EEPROM), a Phase change RAM (PRAM), a Magnetic RAM (MRAM), a NAND or NOR flash memory, a Phase Change Random Access Memory (PCRAM), a Resistive Random Access Memory (RRAM), a Ferroelectric Random Access Memory (FRAM), a Spin Transfer Torque Magnetic Random Access Memory (STT-MRAM), a holographic memory device, a hard disk drive (HDD), and any other type of nonvolatile memory device.

According to an embodiment, the memory device 250 can include a plurality of flash memory devices. The flash memory device can include a NAND or NOR based flash memory device, and can store data based on an amount of charge contained in a floating gate of the transistor for each flash memory cell. In the NAND flash memory device, the flash memory device can be divided into a plurality of blocks, and the blocks can be divided into a plurality of pages. Each block of the plurality of blocks within a particular memory device can include a plurality of NAND cells. Rows of NAND cells can be electrically connected using word lines to establish the plurality of pages. Each cell in each of the plurality of pages can be electrically connected to a respective bit line. Additionally, the NAND flash memory device can be a 2D or 3D device. The flash memory device can include single level cells (SLC), multi-level cells (MLC), triple level cells (TLC), quad level cells (QLC), or higher level cells. The controller 230 can write and read data to and from the NAND flash memory device at the page level, and can erase data stored in the NAND flash memory device at the block level.

A portion of the memory device 250 can be formatted as a logical block, zone, or area such that a storage capacity of the memory device 250 is divided into multiple streams. Each stream can include plural physical blocks or plural erase blocks of the memory device 250. Each physical block can be associated with plural logical blocks. Each logical block can be associated with a unique LBA or sector. Each stream can have a size that is tailored to a storage capacity of one or more physical blocks of the memory device 250. When the controller 230 receives a command such as from the host 202, the controller 230 can read and write data from plural logical blocks associated with plural physical blocks of the memory device 250.

The memory system 210 can include a power supply circuit configured to provide power to at least one component. When operating in a standard or normal mode, the power supply circuit can use power provided by an external device, such as the host 202, to power the one or more components. For example, the power supply circuit can power one or more components using power received from the host 202 via the host interface 220. According to an embodiment, the power supply circuit can include one or more power auxiliary devices configured to power one or more components when operating in a shutdown mode, such as when power input from an external device is interrupted. Examples of power auxiliary devices can include, but are not limited to, capacitors, supercapacitors, batteries, etc. According to an embodiment, the amount of power that can be stored by the one or more power storage components can correspond to a function of the cost and/or size (e.g., area/volume) of the one or more power storage components. As the amount of power stored by the one or more power storage components increases, the cost and/or size of the one or more power storage components can also increase.

The memory system 210 can also include a volatile memory device which the controller 230 may use to temporarily store data or information. The volatile memory device can include one or more volatile memories. For example, the controller 230 can use the volatile memory as a cache. The controller 230 can store cached data or information in the volatile memory until the cached data or information is completely written to the memory device 250. Examples of volatile memory can include, but are not limited to, RAM, DRAM, SRAM, and SDRAM (e.g., DDR1, DDR2, DDR3, DDR3L, LPDDR3, DDR4, LPDDR4, DDR5, LPDDR5, etc.).

Different types of volatile memories can be used with different access properties. For example, DRAM can be arranged for longer burst accesses to allow for improved bandwidth of the same access bus. Alternatively, DRAM can be used with smaller accesses so that random small accesses have better latency. The controller 230 can include additional optional SRAM and/or embedded MRAM. Embedded MRAM is another alternative memory that can be used in other embodiments. Similarly, while access to MRAM may be optimized for various design purposes, the amount of embedded MRAM in the controller 230 could be cost-sensitive. Thus, the choice of how much data and what data goes into premium non-volatile memory and premium volatile memory can be influenced by system tradeoffs.

The controller 230 within the memory system 210 can manage one or more operations of the memory system 210. For example, the controller 230 can include plural pipelines for parallel processing. The controller 230 can include at least one processor or core. Data input/output commands input from the host 300 or commands generated within the controller 230 can be divided into multiple stages or tasks for parallel processing, which could be processed. Plural pipelines can divide command processing into multiple stages or tasks so that at least one core can perform tasks for multiple threads simultaneously. According to an embodiment, the plural pipelines can be configured to perform command processing through a superscalar technique that has multiple cores capable of processing the plural pipelines.

Referring to FIGS. 1 and 2, the controller 230 in the memory system 210 can control the buffer 232 in response to the notification (SSR-SET) and the clear notification (SSR-CLEAR) for the slack space recycling (SSR), which are input from the host 300, 100. The buffer 232 can be established or set for processing or storing data and metadata transmitted from the host 300. According to an embodiment, the buffer 232 can be classified by its purpose of usage based on a type of data. For example, the buffer 232 can be classified as a read data buffer established or set for storing read data, a write data buffer established or set for storing write data, a metadata buffer established or set for storing metadata, etc. The controller 230 can adjust or coordinate sizes of plural spaces or areas classified according to the type of data in the buffer 232 based on the notification (SSR-SET) and the clear notification (SSR-CLEAR) for slack space recycling (SSR) transmitted by the host (300, 100). Adjusting multiple spaces or multiple areas in the buffer 232 will be described later with reference to FIG. 8.

FIG. 3 illustrates a configuration of a memory system according to an embodiment of the present disclosure.

Referring to FIG. 3, the data processing system 500 may include a host 502 engaged or coupled with a memory system 510. For example, the host 502 and the memory system 510 can be coupled to each other via a data bus, a host cable and the like to perform data communication.

The memory system 510 may include a memory device 550 and a controller 530. The memory device 550 and the controller 530 in the memory system 510 may be considered components or elements physically separated from each other. The memory device 550 and the controller 530 may be connected via at least one data path. For example, the data path may include a channel and/or a way.

The memory device 550 can include plural memory chips (e.g., flash chips) 552 coupled to the controller 530 through plural channels CH0, CH1, . . . , CHn and ways W0, . . . , W_k. The memory chip 552 can include a plurality of memory planes or a plurality of memory dies. According to an embodiment, the memory plane may be considered a logical or a physical partition including at least one memory block, a driving circuit capable of controlling an array including a plurality of non-volatile memory cells, and a buffer that can temporarily store data inputted to, or outputted from, non-volatile memory cells. Each memory plane or each memory die can support an interleaving mode in which plural data input/output operations are performed in parallel or simultaneously. According to an embodiment, memory blocks included in each memory plane, or each memory die, included in the memory device 550 can be grouped as a super memory block to input/output plural data entries. An internal configuration of the memory device 550 shown in FIG. 3 may be changed based on operating performance of the memory system 510. An embodiment of the present disclosure may not be limited to the internal configuration described in FIG. 3.

According to an embodiment, the memory device 550 and the controller 530 may be components or elements functionally divided. Further, according to an embodiment, the memory device 550 and the controller 530 may be implemented with a single chip or a plurality of chips.

The controller 530 may perform a data input/output operation (such as a read operation, a program operation, an erase operation, etc.) in response to a request or a command input from an external device such as the host 502. For example, when the controller 530 performs a read operation in response to a read request input from an external device, data stored in a plurality of non-volatile memory cells included in the memory device 550 is transferred to the controller 530. Further, the controller 530 can independently perform an operation regardless of the request or the command input from the host 502. Regarding an operating state of the memory device 550, the controller 530 can perform an operation such as garbage collection (GC), wear leveling (WL), a bad block management (BBM) for checking whether a memory block is bad and handling a bad block.

Each memory chip 552 can include a plurality of memory blocks. The memory blocks may be understood to be a group of non-volatile memory cells in which data is removed together by a single erase operation. Although not illustrated, the memory block may include a page which is a group of non-volatile memory cells that store data together during a single program operation or output data together during a single read operation. For example, one memory block may include a plurality of pages. The memory device 550 may include a voltage supply circuit capable of supplying at least one voltage into the memory block. The voltage supply circuit may supply a read voltage, a program voltage, a pass voltage, or an erase voltage into a non-volatile memory cell included in the memory block.

The host 502 interworking with the memory system 510, or the data processing system 510 including the memory system 510 and the host 502, is a mobility electronic device (such as a vehicle), a portable electronic device (such as a mobile phone, an MP3 player, a laptop computer, or the like), and a non-portable electronic device (such as a desktop computer, a game machine, a TV, a projector, or the like). The host 502 may provide interaction between the host 502 and a user using the data processing system 500 or the memory system 510 through at least one operating system (OS). The host 502 transmits a plurality of commands corresponding to a user's request to the memory system 510, and the memory system 510 performs data input/output operations corresponding to the plurality of commands (e.g., operations corresponding to the user's request).

Referring to FIG. 3, the controller 530 in a memory system operates along with the host 502 and the memory device 550. As illustrated, the controller 530 may include a layered structure including the host interface layer (HIL) 550, a flash translation layer (FTL) 540, and a flash interface layer (FIL, or a memory interface layer) 560.

The host interface layer (HIL) 550, the flash translation layer (FTL) 540, and the flash interface layer (FIL) 560 described in FIG. 3 are illustrated as one embodiment. The host interface layer (HIL) 550, the flash translation layer (FTL) 540, and the flash interface layer (FIL) 560 may be implemented in various forms according to the operating performance of the memory system 510. According to an embodiment, the host interface layer (HIL) 550, the flash translation layer (FTL) 540, and the flash interface layer (FIL) 560 can perform operations through multi cores or processors having a pipelined structure included in the controller 530.

The host 502 and the memory system 510 may use a predetermined set of rules or procedures for data communication or a preset interface to transmit and receive data therebetween. For example, the host interface 532 in the memory system 510 can include a device that can transmit signals, data, etc. to the host 502 or receive signals, data, etc. transmitted from the host 502. According to an embodiment, the host interface 532 can be implemented or driven through firmware called a host interface layer (HIL, hereinafter referred to as ‘HIL’) as an area that transmits and receives data with the host 502.

A buffer manager 580 included in the controller 530 can control the input/output of data or operation information in conjunction with the host interface layer (HIL) 550, the flash translation layer (FTL) 540, and the flash interface layer (FIL) 560. To this end, the buffer manager 580 can set or establish various buffers, caches, or queues in a memory, and control data input/output of the buffers, the caches, or the queues, or data transmission between the buffers, the caches, or the queues in response to a request or a command generated by the host interface layer (HIL) 550, the flash translation layer (FTL) 540, and the flash interface layer (FIL) 560. For example, the controller 530 may temporarily store read data provided from the memory device 550 in response to a request from the host 502 before providing the read data to the host 502. Also, the controller 530 may temporarily store write data provided from the host 502 in a memory before storing the write data in the memory device 550. When controlling operations such as a read operation, a program operation, and an erase operation performed within the memory device 550, the read data or the write data transmitted or generated between the controller 530 and the memory device 550 in the memory system 510 could be stored and managed in a buffer, a queue, etc. established in the memory by the buffer manager 580. Besides the read data or the write data, the buffer manager 580 can store signal or information (e.g., map data, a read command, a program command, or etc. which is used for performing operations such as programming and reading data between the host 502 and the memory device 550) in the buffer, the cache, the queue, etc. established in the memory. The buffer manager 580 can set, or manage, a command queue, a program memory, a data memory, a write buffer/cache, a read buffer/cache, a data buffer/cache, a map buffer/cache, and etc.

The host interface layer (HIL) 550 may handle commands, data, and the like transmitted from the host 502. By way of example but not limitation, the host interface layer 550 may include a command queue manager 522 and an event queue manager 524. The command queue manager 522 may sequentially store the commands, the data, and the like received from the host 502 in a command queue, and output them to the event queue manager 524, for example, in an order in which they are stored in the command queue manager 522. The event queue manager 524 may sequentially transmit events for processing the commands, the data, and the like received from the command queue. According to an embodiment, the event queue manager 524 may classify, manage, or adjust the commands, the data, and the like received from the command queue. Further, according to an embodiment, the host interface layer 550 can include an encryption manager (Encyp) 526 configured to encrypt a response or output data to be transmitted to the host 502 or to decrypt an encrypted portion in the command or data transmitted from the host 502.

A plurality of commands or data of the same characteristic may be transmitted from the host 502, or a plurality of commands and data of different characteristics may be transmitted to the memory system 510 after being mixed or jumbled by the host 502. For example, a plurality of commands for reading data, i.e., read commands, may be delivered, or commands for reading data, i.e., a read command, and a command for programming/writing data, i.e., a write command, may be alternately transmitted to the memory system 510. The command queue manager 522 of the host interface layer 550 may sequentially store commands, data, and the like, which are transmitted from the host 502, in the command queue. Thereafter, the host interface layer 550 may estimate or predict what type of internal operations the controller 530 will perform according to the characteristics of the commands, the data, and the like, which have been transmitted from the host 502. The host interface layer 550 may determine a processing order and a priority of commands, data and the like based on their characteristics. According to the characteristics of the commands, the data, and the like transmitted from the host 502, the event queue manager 524 in the host interface layer 550 is configured to receive an event, which should be processed or handled internally within the memory system 510 or the controller 530 according to the commands, the data, and the like input from the host 502, from the buffer manager 580. Then, the event queue manager 524 can transfer the event including the commands, the data, and the like into the flash translation layer (FTL) 540.

According to an embodiment, the flash translation layer (FTL) 540 may include a host request manager (HRM) 542, a map manager (MM) 544, a state manager (GL/WL) 546, and a block manager BM/BBM) 548. Further, according to an embodiment, the flash translation layer (FTL) 540 may implement a multi-thread scheme to perform data input/output (I/O) operations. A multi-thread FTL may be implemented through a multi-core processor using multi-thread included in the controller 530. For example, the host request manager (HRM) 542 may manage the events transmitted from the event queue. The map manager (MM) 544 may handle or control map data. The state manager 546 may perform an operation such as garbage collection (GC) or wear leveling (WL), after checking an operating state of the memory device 550. The block manager 548 may execute commands or instructions onto a block in the memory device 550.

The host request manager (HRM) 542 may use the map manager (MM) 544 and the block manager 548 to handle or process requests according to read and program commands and events which are delivered from the host interface layer 550. The host request manager (HRM) 542 may send an inquiry request to the map manager (MM) 544 to determine a physical address corresponding to a logical address which is entered with the events. The host request manager (HRM) 542 may send a read request with the physical address to the flash interface layer 560 to process the read request, i.e., handle the events. In one embodiment, the host request manager (HRM) 542 may send a program request (or a write request) to the block manager 548 to program data to a specific empty page storing no data in the memory device 550, and then may transmit a map update request corresponding to the program request to the map manager (MM) 544 in order to update an item relevant to the programmed data in information for mapping the logical and physical addresses to each other.

The block manager 548 may convert a program request delivered from the host request manager (HRM) 542, the map manager (MM) 544, and/or the state manager 546 into a flash program request used for the memory device 550, to manage flash blocks in the memory device 550. To maximize or enhance program or write performance of the memory system 510, the block manager 548 may collect program requests and send flash program requests for multiple-plane and one-shot program operations to the flash interface layer 560. In an embodiment, the block manager 548 sends several flash program requests to the flash interface layer 560 to enhance or maximize parallel processing of a multi-channel and multi-directional flash controller.

In an embodiment, the block manager 548 may manage blocks in the memory device 550 according to the number of valid pages, select and erase blocks having no valid pages when a free block is needed and select a block including the least number of valid pages when it is determined that garbage collection is to be performed. The state manager 546 may perform garbage collection to move valid data stored in the selected block to an empty block and erase data stored in the selected block so that the memory device 550 may have enough free blocks (i.e., empty blocks with no data).

When the block manager 548 provides information regarding a block to be erased to the state manager 546, the state manager 546 may check all flash pages of the block to be erased to determine whether each page of the block is valid. For example, to determine validity of each page, the state manager 546 may identify a logical address recorded in an out-of-band (OOB) area of each page. To determine whether each page is valid, the state manager 546 may compare a physical address of the page with a physical address mapped to a logical address obtained from an inquiry request. The state manager 546 sends a program request to the block manager 548 for each valid page. A map table may be updated by the map manager 544 when a program operation is complete.

The map manager 544 may manage map data, e.g., a logical-physical map table. The map manager 544 may process various requests, for example, queries, updates, and the like, which are generated by the host request manager (HRM) 542 or the state manager 546. The map manager 544 may store the entire map table in the memory device 550, e.g., a flash/non-volatile memory, and cache mapping entries according to the storage capacity of the buffer 232. When a map cache miss occurs while processing inquiry or update requests, the map manager 544 may send a read request to the flash interface layer 560 to load a relevant map table stored in the memory device 550. When the number of dirty cache blocks in the map manager 544 exceeds a certain threshold value, a program request may be sent to the block manager 546, so that a clean cache block is made and a dirty map table may be stored in the memory device 550.

When garbage collection is performed, the state manager 546 copies valid page(s) into a free block, and the host request manager (HRM) 542 may program the latest version of the data for the same logical address of the page and concurrently issue an update request. When the state manager 546 requests the map update in a state in which the copying of the valid page(s) is not completed normally, the map manager 544 may not perform the map table update. This is because the map request is issued with old physical information when the state manager 546 requests a map update and a valid page copy is completed later. The map manager 544 may perform a map update operation to ensure accuracy when, or only if, the latest map table still points to the old physical address.

The flash interface layer (FIL) 560 may exchange data, commands, state information, and the like, with a plurality of memory chips 552 in the memory device 550 through a data communication method. According to an embodiment, the flash interface layer 560 may include a status check schedule manager (SM/SC) 562 and a data path manager (DPC) 564. The status check schedule manager 562 can check and determine the operating state regarding the plurality of memory chips 552 coupled to the controller 530, the operating state regarding a plurality of channels CH0, CH1, . . . , CHn and the plurality of ways W0, . . . , W_k, and the like. The transmission and reception of data or commands can be scheduled in response to the operating states regarding the plurality of memory chips 552 and the plurality of channels CH0, CH1, . . . , CHn. The data path manager 564 can control the transmission and reception of data, commands, etc. through the plurality of channels CH0, CH1, . . . , CHn and ways W0, . . . , W_k based on the information transmitted from the status check schedule manager 562. According to an embodiment, the data path manager 564 may include a plurality of transceivers, each transceiver corresponding to each of the plurality of channels CH0, CH1, . . . , CHn. Further, according to an embodiment, the status check schedule manager 562 and the data path manager 564 included in the flash interface layer 560 could be implemented as, or engaged with, a memory control sequence generator.

According to an embodiment, the flash interface layer 560 may further include an ECC (error correction code) circuitry 566 configured to perform error checking and correction of data transferred between the controller 530 and the memory device 550. The ECC circuitry 566 may be implemented as a separate module, circuit, or firmware in the controller 530, but may also be implemented in each memory chip 552 included in the memory device 550 according to an embodiment. The ECC circuitry 566 may include a program, a circuit, a module, a system, or an apparatus for detecting and correcting an error bit of data processed by the memory device 550.

For finding and correcting any error of data transferred from the memory device 550, the ECC circuitry 566 can include an error correction code (ECC) encoder and an ECC decoder. The ECC encoder may perform error correction encoding of data to be programmed in the memory device 550 to generate encoded data into which a parity bit is added and store the encoded data in the memory device 550. The ECC decoder can detect and correct error bits contained in the data read from the memory device 550 when the controller 530 reads the data stored in the memory device 550. For example, after performing error correction decoding on the data read from the memory device 550, the ECC circuitry 566 can determine whether the error correction decoding has succeeded or not, and outputs an instruction signal, e.g., a correction success signal or a correction fail signal, based on a result of the error correction decoding. The ECC circuitry 566 may use a parity bit, which has been generated during the ECC encoding process for the data stored in the memory device 550, to correct the error bits of the read data entries. When the number of the error bits is greater than or equal to the number of correctable error bits, the ECC circuitry 538 may not correct the error bits and instead may output the correction fail signal indicating failure in correcting the error bits.

According to an embodiment, the error correction circuitry 538 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), or the like. The error correction circuitry 538 may include all circuits, modules, systems, and/or devices for performing the error correction operation based on at least one of the above-described codes.

For example, the encoder in the ECC circuitry 566 may generate a codeword that is an ECC-applied data unit. A codeword of length n bits may include k bits of user data and (n-k) bits of parity. A code rate may be calculated as (k/n). The higher the code rate, the more user data that can be stored in a given codeword. When the length of the codeword is longer and the code rate is smaller, the error correction capability of the ECC circuitry 566 could be improved. In addition, the ECC circuitry 566 performs decoding using information read from the channels CH0, CH1, . . . , CHn. The decoder in the ECC circuitry 566 can be classified into a hard decision decoder and a soft decision decoder according to how many bits represent the information to be decoded. A hard decision decoder performs decoding with a memory cell output information expressed in 1 bit, and the 1-bit information used at this time is called hard decision information. A soft decision decoder uses more accurate memory cell output information composed of 2 bits or more, and this information is called soft decision information. The ECC circuitry 566 may correct errors included in data using the hard decision information or the soft decision information.

According to an embodiment, to increase the error correction capability, the ECC circuitry 566 may use a concatenated code using two or more codes. In addition, the ECC circuitry 566 may use a product code that divides one codeword into several rows and columns and applies a different relatively short ECC to each row and column.

In accordance with an embodiment, a manager included in the host interface layer 550, the flash translation layer (FTL) 540, and the flash interface layer (FIL) 560 could be implemented with a general processor, an accelerator, a dedicated processor, a co-processor, a multi-core processor, or the like. According to an embodiment, the manager can be implemented with firmware working with a processor.

The memory device 550 can correspond to the memory device 250 described in FIG. 2. According to an embodiment, the memory device 550 can include a plurality of memory devices providing the same characteristics and the same size of storage space, or may include a plurality of memories providing different characteristics and different sizes of storage space. In addition, the memory device 550 can include a plurality of storage spaces or areas capable of distributing and storing data. The ECC module 566 can generate parity of data distributed and stored in the plurality of storage spaces or areas.

According to an embodiment, the memory system 510 may support dividing a storage area in which data entries are stored in the memory device 550 based on a preset standard and dedicating each of divided areas to a specific range of logical block addresses (LBA). When supporting zoned namespaces, the memory system 510 can increase access efficiency and reduce an access time by using a logical block address range dedicated for each area rather than using a specific logical block address range that spans multiple areas. For example, zoned namespaces can improve write performance, which can be useful for workloads that require sequential writes of large amounts of data, such as video streaming or data backup.

FIG. 4 illustrates a host file system and a memory system according to an embodiment of the present disclosure.

Referring to FIG. 4, the host file system 604 can include a log-structured file system. The host file system 604 can store data in the memory system 610. The host file system 604 can collect small pieces of write data in a segment buffer and then sequentially writes collected data to the memory system 610. The host file system 604 can utilize a maximum bandwidth of the memory system 610 and can have excellent write performance for random writes. However, when reaching an end of the storage space in the memory system 610 during a procedure of writing data, the host file system 604 should perform a cleaning process that is expensive (e.g., resource consumption, time, etc.). The cleaning process can deteriorate the overall write performance of the host file system 604.

The host file system 604 including the log-structured file system can cause a chain of metadata updates because the memory system could always write data to a new location of the non-volatile memory device and should update related metadata. Due to these consecutive metadata updates, the host file system 604 can make or generate more write requests or commands than other file systems.

In a hard disk drive, sequential writes can be much faster than random writes due to mechanical components such as disk heads, spindle motors, and platters. The memory system 610 including a non-volatile memory device can store data in a flash memory device to replace a hard disk drive. Unlike the hard disk drive, the memory system 610 might not require mechanical components. Therefore, the memory system 610 can have advantages such as improved data input/output performance, low power consumption, and shock resistance. Even without mechanical components, the memory system 610 can be faster for sequential writes than random writes due to the characteristics of flash memory and FTL algorithms.

The non-volatile memory devices in the memory system 610 can have a limited lifespan. In addition, the non-volatile memory devices have a limitation in overwriting. Due to the characteristics of such flash memory, the memory system 610 can perform additional operations such as garbage collection and wear leveling, which is distinguishable from an operation of inputting and outputting data based on a request or command transmitted from the host file system 604. Considering the operational characteristics of such memory system 610, the host file system 604 including the log-structured file system could improve the efficiency of resources consumed in data input/output operations through operations such as log-structured file system cleaning (LFS cleaning), hole plugging, and slack space recycling (SSR).

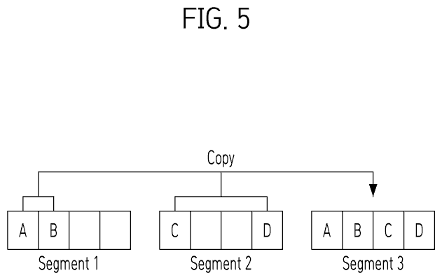

FIG. 5 illustrates an embodiment of log-structured file system cleaning (LFS cleaning).

Referring to FIG. 4 and FIG. 5, when there is no free segment in the host file system 604, the host file system 604 should perform a cleaning process to secure a free segment. For example, data blocks A, B, C, D can be included in two segments (e.g., Segment 1, Segment 2). A log-structured file system (LFS) cleaner can perform log-structured file system cleaning (LFS Cleaning) to secure an empty segment for writing new data. The log-structured file system (LFS) cleaner can copy the data blocks A, B, C, D included in the two segments (e.g., Segment 1, Segment 2) to a third segment (e.g., Segment 3). When data blocks A, B, C, D are copied to the third segment (e.g., Segment 3), two empty segments (e.g., Segment 1, Segment 2) can be secured for new data. The host file system 604 can use two empty segments (e.g., Segment 1, Segment 2) for a new write request.

The log-structured file system cleaning (LFS Cleaning) can be performed in response to a request or as a background operation. For example, when the host file system 604 is busy, the log-structured file system cleaning (LFS Cleaning) can be performed in response to a request or a command. Write requests or commands could be blocked while the log-structured file system cleaning (LFS Cleaning) is performed. In this case, data input/output performance of the host file system 604 might be degraded. On the other hand, when the host file system 604 is idle, the log-structured file system cleaning (LFS Cleaning) could be performed as a background operation. The host file system 604 could prevent data input/output performance from being degraded when performing the log-structured file system cleaning (LFS Cleaning) as a background operation.

The log-structured file system cleaning (LFS Cleaning) can include an operation of cleaning up unused data blocks or re-arranging valid data blocks to optimize a disk space. The log-structured file system cleaning (LFS Cleaning) can be intended to reduce space waste that occurs as data continues to be added due to the nature of the log-structured file. The log-structured file system cleaning (LFS Cleaning) might be necessary to maintain the performance of the log-structured file system (LFS). The log-structured file system cleaning (LFS Cleaning) can increase resource efficiency of the memory system 110 and improve read performance of the memory system 110.

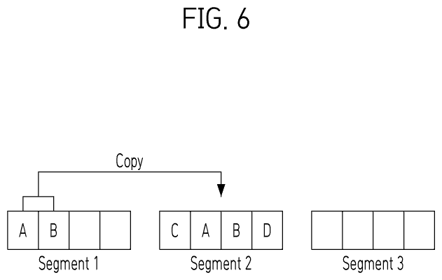

FIG. 6 illustrates an embodiment of hole-plugging.

Referring to FIG. 4 and FIG. 6, the host file system 604 can perform hole-plugging. The hole-plugging can include an operation of filling unused blocks that occur in the log-structured file system (LFS). When data is deleted or modified, an empty space could be created in the corresponding block. The operation of filling the empty space with other data could be called hole-plugging.

For example, through hole-plugging, the log-structured file system (LFS) cleaner can copy valid data blocks A, B of the first segment (e.g., Segment 1) to empty blocks (e.g., holes) of the second segment (e.g., Segment 2). After the valid blocks A, B are copied, the first segment (e.g., Segment 1) can become free. The host file system 604 can use the first segment (e.g., Segment 1) for a new write request. The hole-plugging described in FIG. 6 can outperform the log-structured file system cleaning (LFS Cleaning) described in FIG. 5. However, the hole-plugging described in FIG. 6 can have a limited utility, as compared to the log-structured file system cleaning (LFS Cleaning) described in FIG. 5.

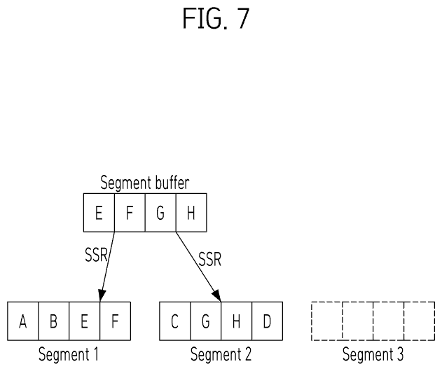

FIG. 7 illustrates an embodiment of slack space recycling.

Referring to FIGS. 4 and 7, the host file system 604 can perform the slack space recycling (SSR) to avoid on-demand cleaning (e.g., on-demand cleaning). A slack space can refer to an invalid area in a used segment. The slack space can be used for new write requests through the slack space recycling (SSR). The slack space recycling (SSR) can directly write modified data in the slack space, instead of performing the log-structured file system cleaning (LFS Cleaning) which is expensive.

For example, the first and second segments (e.g., Segment 1, Segment 2) can include valid data blocks of A, B, C, D. When a write request for new data blocks of E, F, G, H arrives in the segment buffer, there may be no segments available to the host file system 604. Here, the third segment (e.g., Segment 3) is an unavailable segment or a segment that should be kept as an empty space for another operation.

The slack space recycling (SSR) can be performed on data blocks collected in the segment buffer in response to a new write request. Through the slack space recycling (SSR), the host file system 604 can write data blocks E, F of the segment buffer to a slack space in the first segment (e.g., Segment 1) and write data blocks G, H of the segment buffer to another slack space in the second segment (e.g., Segment 2). Slack space recycling (SSR) can avoid or reduce on-demand cleaning by maintaining available segments for new operations without requiring additional data movement (e.g., copying) such as the log-structured file system cleaning (LFS Cleaning) or the hole-plugging.

The slack space recycling (SSR) is an operation to recycle slack space in the host file system 604, and is a type of method used for efficiently using free space that occurs when a file is stored. A slack space can refer to a wasted space that occurs due to the difference between a physical structure and a logical structure of the storage medium in the memory system 110. That is, slack space is a type of space that exists physically but cannot be used logically. Referring to FIGS. 1 to 7, the host file system 604 in the host 100, 300 can recognize the memory system 110, 210, 510, 610 as a disk and can perform a task of reading or writing data in a sector unit. However, data size or length of the file can be variable. The slack space can occur due to a difference in the size of the file, the size of the sector, the size of the cluster, or etc. The slack space can be divided into a RAM slack, a drive slack, a file system slack, a volume slack, or etc.

For example, the RAM slack can occur when data stored in a volatile memory device by the host file system 604 is stored in the memory system 110. Even if the host file system 604 allocates data through a collection of logical sectors such as clusters or blocks, data can be physically stored in the memory system 110, 210, 510, 610 in the sector unit (e.g., 512 bytes). The host 100, 300 with a cluster size of 2 KB (e.g., 2048 bytes) can store a file of 712 bytes in the memory system 110, 210, 510, 610. The host file system 604 can logically store a first 512-byte data, out of a 712-byte data, in a first sector of the memory system 110, 210, 510, 610, and logically store the remaining 200-byte data in a second sector of the memory system 110. The host file system 604 can fill 312 bytes of the second sector, excluding 200 bytes, out of 512 bytes of the second sector with meaningless data such as ‘0’. The space filled with meaningless data can be the RAM slack. The host file system 604 can fill the space such as the RAM slack with valid data through the slack space recycling (SSR).

Drive slack can refer to space wasted due to the use of the cluster. When the host 100, 300 with a cluster size of 2 KB (2048 bytes) stores a file of 712 bytes in the memory system 110, 210, 510, 610, instead of using only two sectors to store 712 bytes, one cluster could be used. In this case, no work may be performed on the other two sectors included in one cluster. When data input/output is performed in a unit of cluster, an unallocated area remaining after allocating data can become the drive slack. The host file system 604 can fill a space such as the drive slack with valid data through the slack space recycling (SSR).

The RAM slack and the drive slack above described are also called a file slack. This is because both the RAM slack and the drive slack are a type of slack spaces that appear by being written to a file.

The file system slack can be determined based on a data unit (e.g., a cluster size) used by the host file system 604 to store data in the memory system 110, 210, 510, 610. The last part of the data unit set by the host file system 604 that is not fully filled with data and is not used is the file system slack. The file system slack can be a wasted space that occurs due to the difference between a size of the data allocated by the host file system 604 and a preset partition size. For example, if the host file system 604 uses a 4 KB cluster for 1002 KB of data, the last 2 KB might be an unused space, e.g., the file system slack. The host file system 604 can fill the space such as the File System Slack with valid data through the Slack Space Recycling (SSR).

The volume slack can refer to wasted space resulting from a difference between a total volume size and an allocated partition size. The volume slack can include the remaining space after allocating the memory device 250, 550 in the memory system 110, 210, 510, 610 to logical units which are partition units. Because a size of a partition could be arbitrarily changed in response to a user's request, the size of volume slack can also be arbitrarily changed, unlike the file slack. The host file system 604 can fill a space such as the volume slack with valid data through the slack space recycling (SSR).

When a data segment is configured through the LFS cleaning, the hole-plugging, the slack space recycling, etc. as described in FIGS. 5 to 7, the host file system 604 can configure metadata corresponding to a data segment through operations such as cascading meta-data update or Lazy Indirect Block Update (LIBU). The data segment and the metadata configured by the host file system 604 can be transferred to the memory system 110, 210, 510, 610 and then stored in the memory device 250, 550.

FIG. 8 illustrates buffer control of a memory system according to an embodiment of the present disclosure. Specifically, FIG. 8 describes a method for controlling the usage of a buffer for processing data and metadata based on the notification (SSR-SET) and the clear notification (SSR-CLEAR) associated with the slack space recycling (SSR) by the memory system 110 described in FIG. 1.

Referring to FIGS. 1 to 8, according to an embodiment, a buffer 232 can be divided into three areas or three spaces which are used for different purposes. For example, a storage capacity of the buffer 232 can be divided into a write cache capable of storing write data, a read cache capable of storing read data, and a map cache capable of storing metadata.

In a normal mode, the buffer 232 can be divided into a write cache, a read cache, and a map cache at a preset ratio. When switching from the normal mode to an SSR Mode, the spaces of Write Cache and Read Cache in the buffer (232) could decrease, and the space of Map Cache could increase.

Conversely, when switching from the SSR Mode to the normal mode, the spaces of Write Cache and Read Cache in the buffer 232 could increase, and the space of Map Cache could decrease.

According to an embodiment, a ratio or amount of increase or decrease in the Write Cache, the Read Cache, or the Map Cache can vary based on an operation mode.

In addition, according to an embodiment, the host 100 can transmit the ratio or amount of adjustment (e.g., increase or decrease) of the Write Cache, the Read Cache, or the Map Cache to the memory system 110 through the notification (SSR-SET) or the clear notification (SSR-CLEAR) for the slack space recycling (SSR). In addition, the host 100 can request the adjustment (e.g., increase or decrease) of the Write Cache, the Read Cache, or the Map Cache based on a pattern of data input/output commands transmitted to the memory device 100. The memory system 110 can adjust the sizes of the Write Cache, the Read Cache, or the Map Cache established or set in the buffer 232 based on requests or commands of the host 100.

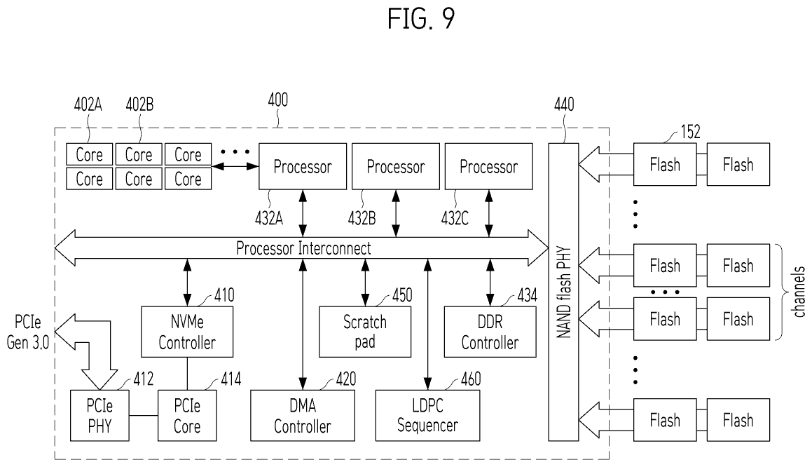

FIG. 9 illustrates a configuration of a memory system according to an embodiment of the present disclosure. FIG. 9 shows a memory system including multiple cores or multiple processors, which is an example of a data storage system. The memory system may support the Non-Volatile Memory Express (NVMe) protocol.

The NVMe is a type of transfer protocol designed for a solid-state memory that could operate much faster than a conventional hard drive. The NVMe can support higher input/output operations per second (IOPS) and lower latency, resulting in faster data transfer speeds and improved overall performance of the data storage system. Unlike SATA which has been designed for a hard drive, the NVMe can leverage the parallelism of solid-state storage to enable more efficient use of multiple queues and processors (e.g., CPUs). The NVMe is designed to allow hosts to use many threads to achieve higher bandwidth. The NVMe can allow the full level of parallelism offered by SSDs to be fully exploited. However, because of limited firmware scalability, limited computational power, and high hardware contention within SSDs, the memory system might not process a large number of I/O requests in parallel.

Referring to FIG. 9, the host, which is an external device, can be coupled to the memory system through a plurality of PCIe Gen 3.0 lanes, a PCIe physical layer (PCIe PHY) 412, and a PCIe core 414. A controller 400 may include three embedded processors 432A, 432B, 432C, each using a plurality of cores 402A, 402B. Herein, the plurality of cores 402A, 402B or the plurality of embedded processors 432A, 432B, 432C may have a pipeline structure.

The plurality of embedded processors 432A, 432B, 432C may be coupled to an internal DRAM controller (DDR controller) 434 through a processor interconnect. The controller 400 further includes a Low Density Parity-Check (LDPC) sequencer 460, a Direct Memory Access (DMA) controller 420, a scratch pad memory 450 for metadata management, and an NVMe controller 410. Components within the controller 400 may be coupled to a plurality of channels connected to a plurality of memory packages (Flash) 152 through a flash physical layer (NAND flash PHY) 440. The plurality of memory packages 152 may correspond to the plurality of memory chips 252 described in FIG. 3.

According to an embodiment, the NVMe controller 410 included in the controller 400 is a type of storage controller designed for use with solid state drives (SSDs) that use an NVMe interface. The NVMe controller 410 may manage data transfer between the SSD and the computer CPU as well as other functions such as error correction, wear leveling, and power management. The NVMe controller 410 may use a simplified, low-overhead protocol to support fast data transfer rates.

According to an embodiment, a scratch pad memory 450 may be a storage area set by the NVMe controller 410 to temporarily store data. The scratch pad memory 450 may be used to store data waiting to be written to a plurality of memory packages 152. The scratch pad memory 450 can also be used as a buffer to speed up the writing process, typically with a small amount of Dynamic Random Access Memory (DRAM) or Static Random Access Memory (SRAM). When a write command is executed, data may first be written to the scratch pad memory 450 and then transferred to the plurality of memory packages 152 in larger blocks. The scratch pad memory 450 may be used as a temporary memory buffer to help optimize the write performance of the plurality of memory packages 152. The scratch pad memory 450 may serve as intermediate storage of data before the data is written to non-volatile memory cells.

The Direct Memory Access (DMA) engine 420 included in the controller 400 is a component that transfers data between the NVMe controller 410 and a host memory in the host system without involving a host's processor. The DMA engine 420 can support the NVMe controller 410 to directly read or write data from or to the host memory without intervention of the host's processor. According to an embodiment, the DMA engine 420 may achieve or support high-speed data transfer between a host and an NVMe device, using a DMA descriptor that includes information regarding data transfer such as a buffer address, a transfer length, and other control information.

The LDPC sequencer 460 in the controller 400 is a component that performs error correction on data stored in the plurality of memory packages 152. Herein, an LDPC code is a type of error correction code commonly used in a NAND flash memory to reduce a bit error rate. The LDPC sequencer 460 may be designed to immediately process encoding and decoding of LDPC codes when reading and writing data from and to the NAND flash memory. According to an embodiment, the LDPC sequencer 460 may divide data into plural blocks, encode each block using an LDPC code, and store the encoded data in the plurality of memory packages 152. Thereafter, when reading the encoded data from the plurality of memory packages 152, the LDPC sequencer 460 can decode the encoded data based on the LDPC code and correct errors that may have occurred during a write or read operation. The LDPC sequencer 460 may correspond to the ECC circuitry 566 described in FIG. 3.

The controllers 530, 400 described in FIGS. 3 and 7 can manage and control status information about memory blocks within the memory devices 150, 152. For example, the controllers 530, 400 can control and update map information for read operations or program operations, and check and update program-erase cycles (P/E Cycles) that estimate or indicate a wear level of memory blocks for wear leveling. Additionally, the controllers 530, 400 can check the read count in the operation information about the memory block. Further, the controllers 530, 440 may have structural information about the internal configuration (e.g., string sharing) of the memory devices 150, 152.

The controllers 530, 400 can read or load firmware from the memory devices 150, 152 for internal operations. In a process of reading or loading the firmware, stress or read disturb can occur in the location and surrounding locations where the firmware is stored. The device and the operating method described in FIGS. 1 to 6 can reduce or avoid degradation of operational safety regarding the plural firmware copies stored in the memory devices 150, 152 due to stress or read disturbance.

In order to ensure the operational safety of the firmware, the controllers 530, 400 can perform data migration, read retry operations, etc. based on read counts and/or erase/write operations (E/W cycles). Through this, the memory system can reduce an error in a process of reading or loading the firmware stored in the memory devices 150, 152 and improve data input/output performance.

As above described, according to an embodiment of the present disclosure, a memory device or a memory system can improve data input/output performance by re-allocating internal resources based on a notification of the slack space recycling (SSR), which is transmitted by a host.

In addition, in a data processing system according to an embodiment of the present disclosure, a read input/output command in a slack space recycling (SSR) state might not be associated with a large size of data but can have many addresses corresponding to the data. In an operating environment where the memory device or the memory system is likely to perform a random read operation rather than a sequential read operation due to a plurality of addresses, a size of a buffer or a cache for storing map data could be increased to reduce operations performed for loading and eviction of map data, so that read performance of the memory device or the memory system could be improved.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments, may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments herein.

The controllers, processors, control circuitry, devices, modules, units, multiplexers, logic, interfaces, decoders, drivers, generators and other signal generating and signal processing features of the embodiments disclosed herein may be implemented, for example, in non-transitory logic that may include hardware, software, or both. When implemented at least partially in hardware, the controllers, processors, control circuitry, devices, modules, units, multiplexers, logic, interfaces, decoders, drivers, generators and other signal generating and signal processing features may be, for example, any of a variety of integrated circuits including but not limited to an application-specific integrated circuit, a field-programmable gate array, a combination of logic gates, a system-on-chip, a microprocessor, or another type of processing or control circuit.

When implemented at least partially in software, the controllers, processors, control circuitry, devices, modules, units, multiplexers, logic, interfaces, decoders, drivers, generators and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments, may transform the computer, processor, controller, or other signal processing device into a special-purpose processor for performing the methods described herein.

While the scope of the present disclosure has been illustrated and described with respect to specific embodiments, it will be apparent to those skilled in the art that various changes and modifications may be made to the embodiments defined in the following claims without departing from the spirit and scope of the present disclosure. Furthermore, the embodiments may be combined to form additional embodiments.

What is claimed is:

1. A memory system comprising:
a memory device configured to store data corresponding to a data input/output command; and
a controller configured to receive, from an external device, the data input/output command and a notification of Slack Space Recycling corresponding to the data input/output command, and control, based on the notification, a buffer for processing data and metadata corresponding to the data input/output command.

2. The memory system according to claim 1, wherein the notification is transmitted from the external device based on log-structured file system cleaning and hole-plugging performed within the external device.

3. The memory system according to claim 2, wherein the notification, the data, and the metadata are generated from a log-structured file system within the external device.

4. The memory system according to claim 1,
wherein the buffer comprises a first buffer established for processing the data and a second buffer established for processing the metadata, and
wherein the controller is configured to reduce a size of the first buffer and increase a size of the second buffer, based on the notification.

5. The memory system according to claim 4,
wherein the data comprises read data or write data corresponding to the data input/output command, and
wherein the first buffer comprises a read buffer for storing the read data and a write buffer for storing the write data.

6. The memory system according to claim 4, wherein the metadata comprises map data corresponding to the data.

7. The memory system according to claim 1, wherein the controller is configured to adjust usage of the buffer based on a termination notification of the Slack Space Recycling, which is transmitted from the external device.

8. The memory system according to claim 7,
wherein the buffer comprises a first buffer established for processing the data and a second buffer established for processing the metadata, and
wherein the controller is configured to increase a size of the first buffer and reduce a size of the second buffer, based on the termination notification.

9. The memory system according to claim 1, wherein the buffer is established in a volatile memory included in, or linked to, the controller.

10. A data processing system comprising:
at least one host configured to generate a data input/output command or a notification of Slack Space Recycling; and
at least one memory system configured to control, based on the notification transmitted from the host, a buffer established for processing the data input/output command.

11. The data processing system according to claim 10, wherein the at least one host is configured to generate the notification after performing log file system cleaning and hole-plugging.

12. The data processing system according to claim 10, wherein the at least one host is configured to generate the notification, the data, and the metadata through a log-structured file system within the at least one host.

13. The data processing system according to claim 12, wherein the log-structured file system comprises a Flash-Friendly File System.

14. The data processing system according to claim 10,
wherein the buffer comprises a first buffer established for processing the data and a second buffer established for processing the metadata, and
wherein the at least one memory system is configured to reduce a size of the first buffer and increase a size of the second buffer, based on the notification.

15. The data processing system according to claim 14,
wherein the data comprises read data or write data corresponding to the data input/output command, and
wherein the first buffer comprises a read buffer established for storing the read data and a write buffer established for storing the write data.

16. The data processing system according to claim 10, wherein the at least one memory system is configured to adjust usage of the buffer based on a termination notification of the Slack Space Recycling, which is transmitted from the at least one host.

17. The data processing system according to claim 16,
wherein the buffer comprises a first buffer established for processing the data and a second buffer established for processing the metadata, and
wherein the at least one memory system is configured to increase a size of the first buffer and reduce a size of the second buffer, based on the termination notification.

18. A method for operating a memory system, the method comprising:
receiving, from a host, a notification of Slack Space Recycling; and
adjusting, based on the notification, usage of buffers established for processing data and metadata corresponding to a data input/output command which is transmitted from the host.

19. The method according to claim 18, wherein the adjusting the usage of the buffers comprises:
reducing, based on the notification, a size of a first buffer established for processing data corresponding to the data input/output command; and
increasing, based on the notification, a size of a second buffer established for processing metadata corresponding to the data input/output command.

20. The method according to claim 18, further comprising:
receiving, from the host, a termination notification of the Slack Space Recycling;
increasing, based on the termination notification, a size of a first buffer established for processing data corresponding to the data input/output command; and
reducing, based on the termination notification, a size of a second buffer established for processing metadata corresponding to the data input/output command.
